(19) United States
(12) Patent Application Publication
(10) Pub. No.: US 2026/0075414 A1
(43) Pub. Date: Mar. 12, 2026

(54) RANGE TRACKING AUTHORIZATION FOR OBTAINING AN EMERGENCY RESPONSE

(71) Applicant: Google LLC, Mountain View, CA (US)

(72) Inventors: Liping Liu, Buffalo Grove, IL (US); Ning Zhang, Saratoga, CA (US)

(21) Appl. No.: 19/252,723

(22) Filed: Jun. 27, 2025

Related U.S. Application Data
(60) Provisional application No. 63/692,885, filed on Sep. 10, 2024.

(51) Int. Cl. H04W 12/06; G06Q 50/26; H04W 12/30; H04W 12/63

(52) U.S. Cl. CPC H04W 12/06; G06Q 50/265; H04W 12/30; H04W 12/63

(57) ABSTRACT

In one example, a mobile device comprises a memory that stores instructions, and one or more processors that execute the instructions to detect an indication of an emergency, responsive to detecting the indication of the emergency, transmit, to a tracking device, authorization information including at least one or more device addresses to cause the tracking device to generate an authorized request for ranging information based on the authorization information, the ranging information including an indication of a distance between the mobile device and the tracking device, receive the authorized request for ranging information from the tracking device, responsive to receiving the authorized request, establish a secure connection with the tracking device, and transmit the ranging information to the tracking device through a secure connection with the tracking device.

This application claims the benefit of U.S. Provisional Patent Application No. 63/692,885, filed 10 Sep. 2024, the entire contents of which is incorporated herein by reference.

### BACKGROUND

A mobile device may include a variety of sensors (e.g., ultra-wideband, WI-FI, BLUETOOTH, global navigation satellite system (GNSS) radios) that are capable of determining the mobile device's location. Users may register their mobile devices to track the location of their mobile device, such as to aid the users in locating their mobile devices.

### SUMMARY

In general, techniques of this disclosure are directed to range tracking authorization for obtaining an emergency response. In some examples, a mobile device may perform single sided (e.g., unilateral) authorization to establish a secure connection with another device without requiring a preexisting interoperability authorization (e.g., bonding, registration, or other device pairing) for the purpose of allowing the mobile device and, accordingly, the mobile device's user to be located during an emergency. For example, the mobile device may provide (e.g., transmit) authorization information that a tracking device may receive. The mobile device may automatically accept requests generated based on the authorization information. As such, the tracking device may obtain ranging information indicating a location (e.g., distance) of the mobile device by sending an authorized request, based on the authorization information, to the first mobile device.

In one example, various aspects of the techniques are directed to a method comprising: detecting, by a mobile device, an indication of an emergency; responsive to detecting the indication of the emergency, transmitting, by the mobile device and to a tracking device, authorization information including at least one or more device addresses to cause the tracking device to generate an authorized request for ranging information based on the authorization information, the ranging information including an indication of a distance between the mobile device and the tracking device; receiving, by the mobile device, the authorized request for ranging information from the tracking device; responsive to receiving the authorized request, establishing, by the mobile device, a secure connection with the tracking device; and transmitting, by the mobile device, the ranging information to the tracking device through a secure connection with the tracking device.

In another example, various aspects of the techniques are directed to a mobile device including a memory that stores instructions; and one or more processors that execute the instructions to: detect an indication of an emergency; responsive to detecting the indication of the emergency, transmit, to a tracking device, authorization information including at least one or more device addresses to cause the tracking device to generate an authorized request for ranging information based on the authorization information, the ranging information including an indication of a distance between the mobile device and the tracking device; receive the authorized request for ranging information from the tracking device; responsive to receiving the authorized request, establish a secure connection with the tracking device; and transmit the ranging information to the tracking device through a secure connection with the tracking device.

In another example, various aspects of the techniques are directed to non-transitory computer-readable storage media storing instructions that, when executed, cause one or more processors to: detect an indication of an emergency; responsive to detecting the indication of the emergency, transmit, to a tracking device, authorization information including at least one or more device addresses to cause the tracking device to generate an authorized request for ranging information based on the authorization information, the ranging information including an indication of a distance between the mobile device and the tracking device; receive the authorized request for ranging information from the tracking device; responsive to receiving the authorized request, establish a secure connection with the tracking device; and transmit the ranging information to the tracking device through a secure connection with the tracking device.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example environment for range tracking authorization for obtaining an emergency response, in accordance with one or more aspects of this disclosure.

FIG. 2 is a block diagram illustrating an example computing system, in accordance with one or more aspects of the present disclosure.

FIG. 3 is a flowchart illustrating a first example process for range tracking authorization for obtaining an emergency response, in accordance with one or more aspects of the present disclosure.

FIG. 4 is a flowchart illustrating a second example process for range tracking authorization for obtaining an emergency response, in accordance with one or more aspects of the present disclosure.

FIG. 5 is a flowchart of an example process for range tracking authorization for obtaining an emergency response, in accordance with one or more aspects of the present disclosure.

### DETAILED DESCRIPTION

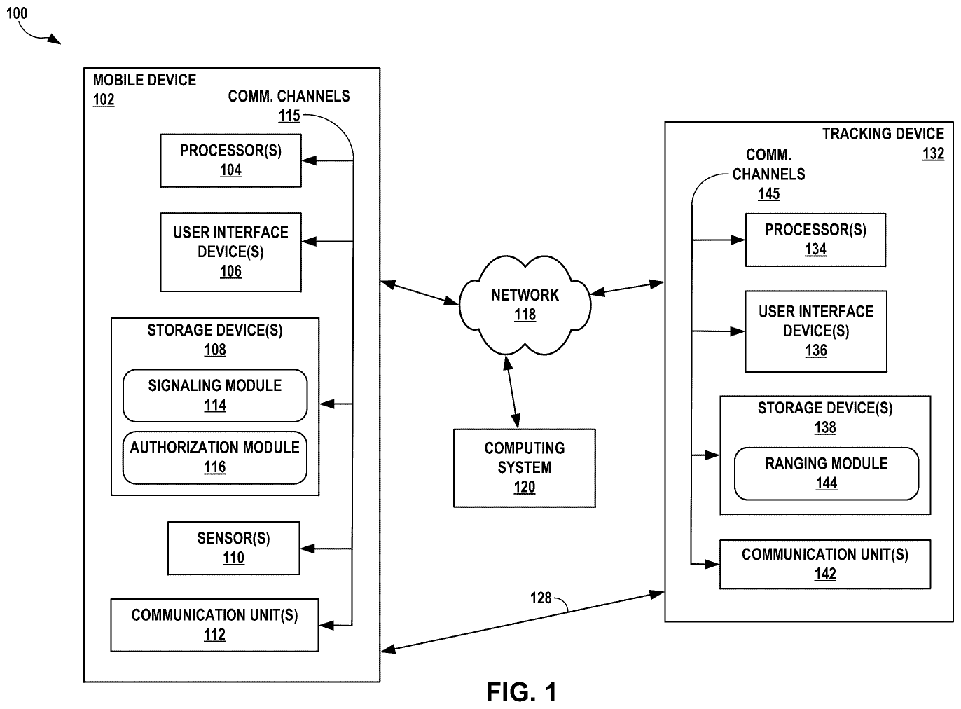

FIG. 1 is a conceptual diagram illustrating an example environment for range tracking authorization for obtaining an emergency response, in accordance with one or more aspects of this disclosure. As can be seen, environment 100 may include one or more mobile devices 102 and one or more tracking devices 132. As will be described further below, environment 100 may, in some examples, include a computing system 120. Computing system 120 may represent an optional repository that stores authorization information that tracking device 132 may use to generate authorized requests to mobile device 102 for the purpose of obtaining ranging information from mobile device 102 that indicates the location (e.g., distance) of mobile device 102. Mobile device 102 may also be referred to herein as a tracked device 102.

Mobile device 102 may represent, for example, a mobile phone, a tablet computer, a laptop computer, a wearable device, a gaming system, a media player, an e-book reader, or any other type of computing device that may provide ranging information to tracking device 132. Examples of ranging information include one or more indications of signal strength (e.g., received signal strength indicators (RSSIs), power level (e.g., decibel (dB) levels), BLUETOOTH channel sounding, WI-FI round trip time (RTT), or other characteristics of communication signals transmitted by mobile device 102 suitable for tracking device 132 to determine a distance to mobile device 102. Ranging information may, in some examples, be an absolute or relative measure of signal strength.

FIG. 1 illustrates a particular example of mobile device 102, and many other examples of mobile device 102 may be used in other instances and may include a subset of the components included in example mobile device 102 or may include additional components not shown in FIG. 1. For instance, mobile device 102 may include or communicate with one or more processors 104, one or more user interface devices 106, one or more storage devices 108, one or more sensors 110, and one or more communications units 112, or various subsets thereof. Communication channels 115 may interconnect each of the components 104, 106, 108, 110, 112 for inter-component communications (physically, communicatively, and/or operatively). In some examples, communication channels 115 may include a system bus, a network connection, an inter-process communication data structure, or any other method for communicating data.

Processor 104 may implement functionality and/or execute instructions for mobile device 102. Examples of processors 104 include, but are not limited to, one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein.

Processor 104 may implement functionality and/or execute instructions for mobile device 102. For example, one or more processors 104 for mobile device 102 may receive and execute instructions stored by one or more storage devices 108 that execute the functionality of signaling module 114 and authorization module 116. The instructions executed by one or more processors 104 may cause mobile device 102 to store information within one or more storage devices 108 during program execution. One or more processors 104 may execute instructions of signaling module 114 and authorization module 116 to perform actions or functions. That is, signaling module 114 and authorization module 116 may be operable by one or more processors 104 to perform various actions or functions of mobile device 102. Signaling module 114 and authorization module 116 may execute at one or more processors 104 to perform functions related to range tracking authorization for obtaining emergency services.

Mobile device 102 may receive user input and/or present output through one or more user interface devices 106 of mobile device 102. User interface device 106 of mobile device 102 may be hardware that functions as an input and/or output device for mobile device 102. For example, user interface device 106 may include a display component (e.g., liquid crystal display (LCD), organic light-emitting diode (OLED) display), which may be a screen at which information is displayed by user interface device 106 and a presence-sensitive input device that may detect an object at and/or near the display component. The presence-sensitive input device may, for example, detect a user's touch or other input. User interface device 106 may provide tactile, audio, and video output. User interface device 106, in some examples, includes one or more of a presence-sensitive display, speaker, liquid crystal display (LCD), organic light-emitting diode (OLED) display, haptic motors, linear actuating devices, or any other type of device for receiving input or generating output to a human or machine.

One or more communication units 112 of mobile device 102 may communicate with external devices via one or more wireless communication links, such as by transmitting and/or receiving wireless signals through one or more networks 118 or directly with the external devices through one or more direct connection links 128. Examples of such communication units 112 include a radio frequency transceiver (e.g., WI-FI radio, cellular radio, ultra-wideband radio, near field communication (NFC) radio, BLUETOOTH radio, shortwave radio), a global navigation satellite system (GNSS) receiver, or any other type of device that can wirelessly send and/or receive information. In some examples, one or more communication units 112 for mobile device 102 may communicate with external devices via one or more wired communication links, such as by transmitting and/or receiving wired signals through one or more networks or directly with the external devices. Examples of such communication units 112 include a network interface card (e.g. Ethernet card), an optical transceiver, universal serial bus (USB) controllers, or any other type of device that can send and/or receive information via a wired connection.

Network 118 may represent any public or private communication network, for instance, cellular, WI-FI, and/or other types of networks, for transmitting data between computing systems, servers, and computing devices. Network 118 may include one or more network hubs, network switches, network routers, or any other network equipment, that are operatively inter-coupled thereby providing for the exchange of information between computing system 120, mobile device 102, tracking device 132, or various subsets thereof. Mobile device 102, tracking device 132, and computing system 120 may transmit and receive data across network 118 using any suitable communication techniques. Each of mobile device 102, tracking device 132, and computing system 120 may be operatively coupled to network 118 using respective network links, such as Ethernet, Wi-Fi, or any other types of wired and/or wireless network connections. Wired and/or wireless connections between devices/systems may be made through respective communication units (e.g., communication unit 112 of mobile device 102 and communication unit 142 of tracking device 132). Direct communication link 128 may be a wireless communication link, such as a BLUETOOTH, WI-FI, ultra-wideband, or other wireless communication link. In some examples, direct communication link 128 may represent a secure communication link (e.g., encrypted link). Mobile device 102 may use direct communication link 128, network 118, or both to communicate with tracking device 132.

One or more storage devices 108 within mobile device 102 may store information for processing during operation of mobile device 102. That is, mobile device 102 may store data accessed by signaling module 114 and/or authorization module 116 during execution at mobile device 102, including authorization information, or other data. In some examples, storage device 108 may be a temporary memory, meaning that a primary purpose of storage device 108 is not long-term storage. One or more storage devices 108 on mobile device 102 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

One or more storage devices 108, in some examples, also include one or more computer-readable storage media. One or more storage devices 108 may be configured to store larger amounts of information than volatile memory. One or more storage devices 108 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. One or more storage devices 108 may store program instructions and/or information (e.g., data) associated with signaling module 114 and authorization module 116. In some examples, one or more storage devices 108 may store an operating system executed by processor 104 to provide an execution environment for signaling module 114, authorization module 116, and/or any applications or processes installed on mobile device 102.

For example, some mobile devices may allow location-based tracking, provided the mobile device has a preexisting interoperability authorization (e.g., a preexisting registration, pairing, or bonding) such as through a registration process (e.g., BLUETOOTH/WI-FI pairing). In contrast, authorization module 116 may provide (e.g., transmit) authorization information to other devices (e.g., tracking device 132, computing system 120) that enables these other devices to securely connect to mobile device 102 without any prerequisite interoperability authorization. Authorization module 116 may provide the authorization information to other devices subject to first obtaining user permission and/or consistent with the user's privacy or other settings.

Authorization information may include device information about mobile device 102. For example, device information may identify one or more features or characteristics of mobile device 102. Examples of device information include device addresses (e.g., BLUETOOTH device addresses, WI-FI or other media access control (MAC) addresses, ultra-wideband addresses) and device identifiers (e.g., unique device identifiers, serial numbers). Units of device information may correspond to elements of mobile device 102. For example, a BLUETOOTH device address may be the device address of a BLUETOOTH communication device 112, a MAC address may be the MAC address of a WI-FI communication device 112, and an ultra-wideband address may be an address of an ultra-wideband communication device 112. Tracking device 132 may use the device information to establish communication with mobile device 102. For example, tracking device 132 may use a device address of communication unit 112 of mobile device 102 to establish communication with mobile device 102 through communication unit 112.

In some examples, device information may include indications of device capabilities, such as capabilities of various components of mobile device 102 (e.g., specifications/capabilities of communication units 112). In addition to device information, authorization information may include keys (e.g., public keys) or other data (e.g., nonces, challenge-response data) suitable for tracking device 132 to generate an authorized request to mobile device 102 (e.g., a request mobile device 102 accepts without any preexisting interoperability authorization).

Authorization module 116 may provide (e.g., transmit) authorization information to other devices (e.g., tracking device 132) through communication unit 112. In some examples, authorization module 116 may broadcast (e.g., transmit) the authorization information directly to tracking device 132. In other examples, authorization module 116 may transmit the authorization information to tracking device 132 through one or more intermediary devices or systems, such as network 118 and/or computing system 120. In these examples, computing system 120 may represent a repository for storage and retrieval of authorization information. For example, computing system 120 may receive and cache (e.g., store) the authorization information from authorization module 116 of mobile device 102. Computing system 120 may send the authorization information to tracking device 132, such as in response to a request from tracking device 132.

After tracking device 132 receives the authorization information, such as from mobile device 102 directly or, alternatively, through computing system 120, tracking device 132 may use the authorization information to generate an authorized request for mobile device 102. For example, tracking device 132 may generate an authorized request addressed to (e.g., including) a device address of mobile device 102 based on the device information in the authorization information. Upon receipt of the authorized request and given that the authorized request is, at least in part, based on the authorization information (e.g., includes the device address), signaling module 114 of mobile device 102 may automatically transmit the ranging information to tracking device 132, such as through direct communication link 128.

As such, by providing the authorization information mobile device 102 may perform single sided authorization of tracking device 132 for communication of ranging information with the tracking device, without needing a preexisting interoperability authorization (e.g., bonding, registration, or other device pairing). Tracking device 132 may then determine the location of mobile device 102 by receiving ranging information from mobile device 102, even when tracking device 132 and mobile device 102 do not have any preexisting interoperability authorization. Communication of the ranging information between mobile device 102 and tracking device 132 also enables tracking device 132 to locate mobile device 102 even in situations where other positioning systems (e.g., GNSS systems) may not be capable of accurately locating mobile device 102. For example, GNSS systems may not be able to locate a user indoors or in dense environments (e.g., dense urban environments) within a suitable margin of error (e.g., 10 meters (m)). Accordingly, by performing single sided authorization of tracking device 132, mobile device 102 improves the ability for emergency responders to physically locate the users of mobile devices 102 for the purpose of providing an emergency response.

Authorization module 116 may provide the authorization information at various times and in response to various events. For example, authorization module 116 may broadcast (e.g., transmit) the authorization information for an emergency (e.g., earthquake, kidnapping) such as in response to mobile device 102 detecting an indication of the emergency. Authorization module 116 may detect an indication of an emergency when mobile device 102 receives user input indicating an emergency, such as a user input indicating the user is in distress (e.g., rapidly depressing the power button multiple times, calling an emergency service number). Mobile device 102 may receive such input through user interface device 106. In some examples, mobile device 102 may have an emergency mode (e.g., SOS mode) that, when activated, may automatically contact emergency services (e.g., call an emergency service number). In such cases, authorization module 116 may detect an indication of an emergency by detecting the activation of the emergency mode.

In some examples, authorization module 116 may detect an indication of an emergency using sensor 110. For example, sensor 110 may represent a motion sensor that outputs sensor information indicating acceleration, speed, rotation, etc. of mobile device 102. Continuing this example, authorization module 116 may detect an emergency when the sensor information from sensor 110 indicates mobile device 102 experienced an event indicative of a fall or a vehicle collision such as based on a rate of deceleration beyond a threshold rate. In some examples, authorization module 116 may detect an indication of an emergency when mobile device 102 receives an emergency alert (e.g., extreme weather alert, disaster alert), such as from a governmental authority, through communication unit 112, sensor 110, or both.

In some examples, rather than transmitting the authorization information directly to tracking device 132, authorization module 116 may transmit the authorization information for the purpose of caching (e.g., storing) the authorization information at another device. In this manner, computing system 120 may store the authorization information prior to an emergency and provide the authorization information if an emergency occurs. For example, authorization module 116 may transmit the authorization information to computing system 120 and computing system 120 may store the authorization information for subsequent retrieval by tracking device 132.

Authorization module 116 may transmit the authorization information to computing system 120 at various times. For example, authorization module 116 may transmit the authorization information to computing system 120 in response to detecting an indication of an emergency, such as described above. For instance, authorization module 116 may transmit the authorization information in response to user input indicating a request for emergency services (e.g., an emergency service call or text message). Computing system 120 may retrieve the authorization information, such as from a storage device of computing system 120 and send the authorization information to tracking device 132. In some examples, rather than transmitting the authorization information in response to detection of an indication of an emergency, authorization module 116 may transmit the authorization information to computing system 120 as part of a registration process with computing system 120 such as to enable mobile device 102 to participate in emergency response services provided by computing system 120.

Authorization module 116 may repeatedly transmit the authorization information, such as at one or more predefined time intervals (e.g., 5 seconds(s), 10 s, 1 minute (min), 5 mins). Authorization module 116 may repeatedly (e.g., periodically) transmit the authorization information until stopped. For example, authorization module 116 may repeatedly transmit the authorization information for a predefined period of time, until tracking device 132 is able to connect to mobile device 102, until receipt of the authorization information is confirmed by tracking device 132 and/or computing system 120, or until transmission is terminated by the user, such as by receipt of user input deactivating the emergency mode of mobile device 102.

Signaling module 114 may transmit ranging information to tracking device 132. As described above, ranging information may indicate a distance between tracking device 132 and mobile device 102. Ranging information may include one or more indications of signal strength (e.g., received signal strength indicators (RSSIs), power level (e.g., decibel (dB) levels), BLUETOOTH channel sounding, WI-FI round trip time (RTT), or other characteristics of communication signals transmitted by mobile device 102 suitable for tracking device 132 to determine a distance to mobile device 102. Ranging information may, in some examples, constitute an absolute or relative measure of signal strength.

Tracking device 132 may receive the ranging information and use the ranging information to track the location of mobile device 102. Tracking device 132 may present an indication of the location of mobile device 102, such as to enable a user of tracking device 132 (e.g., an emergency responder) to locate mobile device 102, thereby facilitating the location of an associated user. To track the location of mobile device 102, tracking device 132 may transmit one or more authorized requests for ranging information to mobile device 102. Responsive to receiving an authorized request, signaling module 114 of mobile device 102 may transmit the ranging information to tracking device 132 through a secure connection. As will be described further below, the secure connection may be established by tracking device 132 and mobile device 102 based on credential information. Direct communication link 128 may be an example of such a secure connection.

Tracking device 132 may represent, for example, a mobile phone, a tablet computer, a laptop computer, a wearable device, or any other type of computing device that may request and receive the ranging information from mobile device 102. In some examples, tracking device 132 may be an example of mobile device 102. For instance, mobile device 102 of FIG. 1 may include ranging module 144 of tracking device 132 to enable mobile device 102 to operate as a tracking device. FIG. 1 illustrates a particular example of tracking device 132, and many other examples of tracking device 132 may be used in other instances and may include a subset of the components included in example tracking device 132 or may include additional components not shown in FIG. 1.

Tracking device 132 may comprise one or more processors 134 and one or more communication units 142. In some examples, tracking device 132 may include one or more user interface devices 136 and one or more storage devices 138. Communication channels 145 may interconnect each of the components 134, 136, 138, 142 for inter-component communications (physically, communicatively, and/or operatively). In some examples, communication channels 145 may include a system bus, a network connection, an inter-process communication data structure, or any other method for communicating data.

Processor 134, user interface device 136, storage device 138, and communication unit 142 of tracking device 132 may be similarly composed as processor 104, user interface device 106, storage device 108, and communication unit 112, respectively, as described above in connection with mobile device 102. For example, processor 134 may implement functionality and/or execute instructions within tracking device 132 to implement the functionality of tracking device 132 and may include integrated or discrete logic circuitry (e.g., DSPs, ASICs, CPUs, FPGAs) or any other hardware configured to function as a processing unit. Processor 134 of tracking device 132 may receive and execute instructions stored by one or more storage devices 138 that execute the functionality of ranging module 144. The instructions executed by one or more processors 134 may cause tracking device 132 to store information within one or more storage devices 138 during program execution. One or more processors 134 may execute instructions of ranging module 144 to perform actions or functions. That is, ranging module 144 may be operable by one or more processors 134 to perform various actions or functions of tracking device 132.

User interface device 136 of tracking device 132 may be hardware that functions as an input and/or output device for tracking device 132. For example, user interface device 136 may include a display component (e.g., liquid crystal display (LCD), organic light-emitting diode (OLED) display), which may be a screen at which information is displayed by user interface device 136 and a presence-sensitive input device that may detect an object at and/or near the display component. The presence-sensitive input device may, for example, detect a user's touch or other input. User interface device 136 may provide tactile, audio, and video output.

One or more storage devices 138 for tracking device 132 may store information for processing during operation of tracking device 132. That is, storage device 138 may store data accessed by ranging module 144, including authorization information and device information and/or credential information thereof, or other data. In some examples, one or more storage devices 138 may store an operating system executed by processor 134 to provide an execution environment for ranging module 144.

One or more communication units 142 of tracking device 132 may communicate with external devices via one or more wired and/or wireless communication links, such as by transmitting and/or receiving wired and/or wireless signals through one or more networks 118 or directly with the external devices. As shown in the example of FIG. 1 for instance, tracking device 132 may communicate with computing system 120 through communication unit 142 and network 118. Mobile device 102 and tracking device 132 may communicate directly via respective communication units (e.g., communication unit 112 and communication unit 142), such as shown by direct communication link 128 between mobile device 102 and tracking device 132 in the example of FIG. 1. Mobile device 102 and tracking device 132 may use direct communication link 128 to communicate data, such as the ranging information. Mobile device 102 may send the authorization information to tracking device 132 through direct communication link 128, network 118, or both.

Ranging module 144 may execute at one or more processors 134, to determine a location of mobile device 102 based on ranging information received from signaling module 114 of mobile device 102. For example, ranging module 144 may determine a distance (e.g., 3 m, 5 m, 10 m) between tracking device 132 and mobile device 102 based on the ranging information. For instance, ranging module 144 may determine the distance to mobile device 102 based on one or more indications of signal strength (e.g., received signal strength indicators (RSSIs), power level (e.g., decibel (dB) levels), or other characteristics of communication signals included in the ranging information transmitted by mobile device 102. In some examples, ranging module 144 may retrieve the distance from a reference table, database, or other data structure that stores the distance for a given indication of signal strength, as shown in the example of Table 1 below.

TABLE 1

| Decibel Level (dBm) | Distance (m) |
|---|---|
| −60 | 1 |
| −70 | 10 |
| −80 | 20 |
| −90 | 40 |

As can be seen from the example of Table 1, ranging module 144 may determine a distance of 1 m for ranging information including an indication of signal strength of substantially −60 dBm, a distance of 10 m for ranging information that includes an indication of signal strength of substantially −70 dBm, a distance of 20 m for ranging information that includes an indication of signal strength of substantially −80 dBm, and so on and so forth. Storage device 138 may store the reference table or data structure. Though shown in the example of Table 1 as having a particular set of data, the reference table or data structure may include additional or other pairings of indications of signal strength and distance. Ranging module 144 may apply a formula to determine the distance by using the indication of signal strength as input to the formula. Ranging module 144 may apply a formula that embodies a reference table such that, for a given indication of signal strength, the formula outputs a distance substantially similar to the corresponding reference table.

Rather than sending the ranging information over an unsecured connection, signaling module 114 of mobile device 102 may utilize a secure (e.g., encrypted) connection with ranging module 144 of tracking device 132 to send the ranging information to tracking device 132. Ranging module 144 may use credential information from mobile device 102 to establish a secure connection with mobile device 102. Credential information may include encryption or other keys (e.g., public keys, private keys, shared keys) as well as nonces (e.g., random data), challenge response data (e.g., random numbers), or other data used to establish a secure connection between tracking device 132 and mobile device 102.

To establish the secure connection, ranging module 144 may perform a verification process whereby ranging module 144 sends verification data (e.g., verification string) to signaling module 114 for verification. Signaling module 114 may verify the verification data by determining the verification data matches counterpart verification data generated by signaling module 114. Ranging module 144 and signaling module 114 may respectively generate the verification data and counterpart verification data using the credential information (e.g., public or other keys, nonces, challenge response data). Upon verification, ranging module 144 and signaling module 114 may establish a secure connection, such as direct communication link 128.

Ranging module 144 and signaling module 114 may not establish any secure connection (or any other type of connection) when signaling module 114 cannot verify the verification data, such as when signaling module 114 determines the verification data from ranging module 144 does not match the counterpart verification data generated by signaling module 114. Though described from a perspective where ranging module 144 transmits the verification data and signaling module 114 verifies the verification data, these roles may be swapped in some examples. For instance, signaling module 114 may generate and send the verification data and ranging module 144 may verify the verification data by generating the counterpart verification data and comparing the verification data to the counterpart verification data.

In some examples, authorization module 116 of mobile device 102 may transmit the credential information as part of the authorization information. For example, when broadcasting the authorization information, authorization module 116 may transmit the credential information along with the authorization information. In contrast, when caching the authorization information, authorization module 116 may transmit the credential information independent of (e.g., separately from) the authorization information. For example, when caching the authorization information, authorization module 116 may transmit authorization information without credential information to computing system 120. In such a case, ranging module 144 may receive the authorization information for mobile device 102 from computing system 120 and separately receive, such as through direct communication link 128, the credential information for mobile device 102 from authorization module 116. Regardless of whether the credential information is transmitted as part of or separately from the authorization information, ranging module 144 and signaling module 114 may use the credential information to establish a secure connection through which ranging information may be communicated.

Ranging module 144 and signaling module 114 may negotiate ranging parameters, such as through the established secure connection. For example, ranging module 144 may determine parameters of ranging information to be provided by signaling module 114 that are compatible with ranging module 144. For instance, ranging module 144 and signaling module 114 may negotiate to determine a format and/or type of indication of signal strength that signaling module 114 can provide and that ranging module 144 can receive and parse. To illustrate, ranging module 144 may determine from signaling module 114 that mobile device 102 can provide an indication of signal strength in the form of an RSSI through communication unit 112 of mobile device 102 that communication unit 142 of tracking device 132 can receive and parse to determine a distance between mobile device 102 and tracking device 132.

In some examples, ranging module 144 and/or signaling module 114 may select one of a plurality of parameters of ranging information that are compatible with mobile device 102 and tracking device 132. For example, ranging module 144 and/or signaling module 114 may prefer an RSSI from a BLUETOOTH communication unit rather than a WI-FI communication unit, or vice versa. In such case, mobile device 102 and tracking device 132 both include BLUETOOTH and WI-FI radios and ranging module 144 and/or signaling module 114 may select the RSSI from one of the radios (e.g., either BLUETOOTH or WI-FI) to use as the parameter of ranging information. Signaling module 114 may send the ranging information to ranging module 144 in the form of the negotiated parameter (e.g., BLUETOOTH RSSI) and ranging module 144 may use the negotiated parameter to determine a distance between tracking device 132 and mobile device 102.

As described above, computing system 120 may constitute a repository for storage and retrieval of authorization information for one or more mobile devices 102. For example, computing system 120 may store the authorization information received from mobile device 102 in a database or other structured data format on a storage device of computing system 120. Computing system 120 may store an indication of the respective mobile device 102 that provided (e.g., sent) the authorization information. In this manner, computing system 120 may retrieve the authorization information for a particular mobile device 102, such as to send the authorization information to tracking device 132. Computing system 120 may communicate with one or more mobile devices 102 and one or more tracking devices 132, such as through network 118.

In examples where the authorization information is stored to computing system 120, rather than receiving the authorization information directly from mobile device 102, tracking device 132 may receive the authorization information from computing system 120. For instance, mobile device 102 may send the authorization information to computing system 120 and computing system 120 may store the authorization information. Tracking device 132 may receive the authorization information for mobile device 102 from computing system 120. Tracking device 132 may use the authorization information, such as the device information therein, to securely receive ranging information from mobile device 102 without a preexisting interoperability authorization between mobile device 102 and tracking device 132 (e.g., an interoperability authorization existing before tracking device 132 received the authorization information).

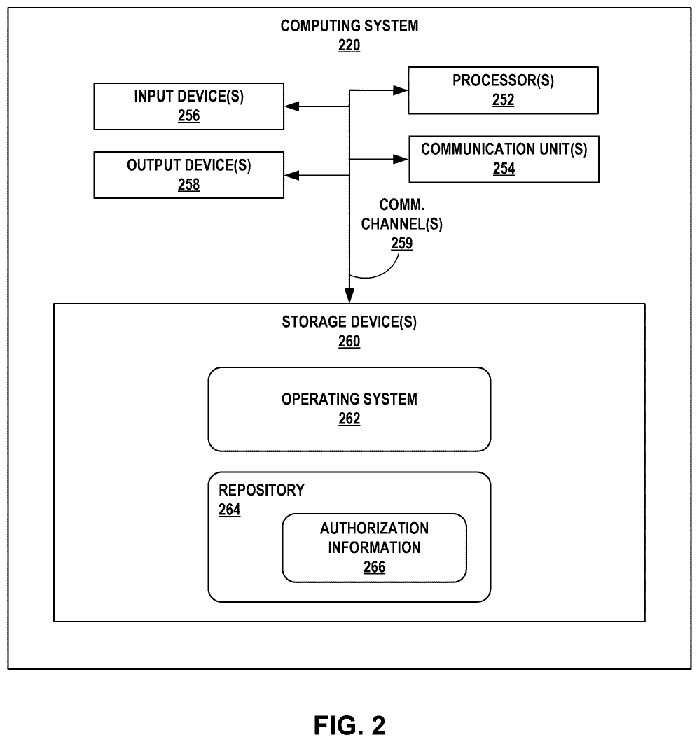

FIG. 2 is a block diagram illustrating an example computing system, in accordance with one or more aspects of the present disclosure. Computing system 220 may be an example of one or more computing devices such as servers, desktop computing devices, computing devices integrated into devices providing a service (e.g., server appliances), among other types of computing devices. As can be seen from the example of FIG. 2, computing system 220 may include one or more processors 252, one or more communication units 254, one or more storage devices 260. In some examples, computing system 220 may include one or more input devices 256 and one or more output devices 258. Computing system 220 may include communication channels 259. Communication channels 259 may interconnect each of the components 252, 254, 256, 258, 260 for inter-component communication (physically, communicatively, and/or operatively). In some examples, communication channels 259 may include a system bus, a network connection, an inter-process communication data structure, or any other method for communicating data. Computing system 220 of FIG. 2 may be an example of computing system 120 of FIG. 1.

One or more communication units 254 of computing system 220 may communicate with external devices via one or more wired and/or wireless networks by transmitting and/or receiving network signals on the one or more networks. Examples of communication units 254 include a network interface card (e.g. an Ethernet card), an optical transceiver, a radio frequency transceiver, a GNSS receiver, or any other type of device that can send and/or receive information. Other examples of communication units 254 may include short wave radios, cellular data radios, wireless network radios, as well as universal serial bus (USB) controllers.

One or more input devices 256 may include one or more components such as keyboards, mice, presence-sensitive housing and/or presence-sensitive display, or other input components. One or more output devices 258 may generate output. Examples of output are tactile, audio, and video output. Output devices 258 of computing system 220, in one example, include a presence-sensitive display, sound card, video graphics adapter card, speaker, OLED, or any other type of device for generating output to a human or machine.

Computing system 220 may provide a user interface to enable a user (e.g., an administrator) to configure and operate computing system 220. For example, computing system 220 may provide a local graphical user interface (GUI) through one or more input devices 256 and/or one or more output devices 258. Computing system 220 may provide a remote user interface, such as a dashboard or other Web user interface (Web UI) through one or more communication units 254. Computing system 220 may receive, such as through the user interface and via input device 256 and/or communication unit 254, user input to manage (e.g., store, update, delete) authorization information 266 received from mobile device 102, such as in examples where computing system 220 is used to cache authorization information 266 and transmit authorization information 266 to tracking device 132.

One or more processors 252 may implement functionality and/or execute instructions within computing system 220. Examples of processors 252 include, but are not limited to, one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. Repository 264 may execute at one or more processors 252 to store authorization information 266 from mobile device 102, such as described above with respect to FIG. 1.

One or more storage devices 260 within computing system 220 may store information for processing during operation of computing system 220. In some examples, storage devices 260 may be temporary memory, meaning that a primary purpose of storage device 260 is not long-term storage. Storage devices 260 on computing system 220 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 260, in some examples, also include one or more computer-readable storage media. Storage devices 260 may be configured to store larger amounts of information than volatile memory. Storage devices 260 may further be configured for long-term storage of information as non-volatile memory space and retain information after power on/off cycles. Examples of non-volatile memories include magnetic hard disks, optical discs, floppy discs, flash memories, or forms of electrically programmable memories (EPROM) or electrically erasable and programmable (EEPROM) memories. Storage devices 260 may include operating system 262 and repository 264. Operating system 262 may provide an execution environment for one or more applications, such as repository 264.

Repository 264 may store authorization information 266 that computing system 220 receives from mobile devices, such as mobile device 102 of FIG. 1. Repository 264 may store authorization information 266 and other data in a database or other structured data format. Repository 264 may manage (e.g., store, update, delete) authorization information 266 stored in repository 264. For each unit (e.g., entry) of authorization information 266, repository 264 may store an indication of the respective mobile device that provided (e.g., transmitted) the unit of authorization information 266. For example, each mobile device may have a unique identifier (e.g., device address, device identifier) that repository 264 may store along with the respective unit of authorization information 266 that computing system 220 receives from the mobile device. Repository 264 may receive a request for authorization information 266 for a particular mobile device, from a tracking device, such as tracking device 132 of FIG. 1. The tracking device may include an indication of the particular mobile device such as a unique identifier of the particular mobile device in the request. Repository 264 may retrieve authorization information 266 for the particular mobile device based on the indication of the particular mobile device and send one or more units of authorization information 266 for the particular mobile device to tracking device 132. Repository 264 may send authorization information 266 to tracking device 132 through communication unit 254 of computing system 220.

In some examples, computing system 220 may represent an emergency dispatch system (e.g., public safety answering point (PSAP) system) or a portion thereof. As such, computing system 220 may receive one or more indications of requests for emergency services (e.g., emergency service calls and text messages) from various mobile devices. Computing system 220 may receive authorization information 266 from a mobile device, along with or in connection with (e.g., during) a request for emergency services. For example, mobile device 102 of FIG. 1 may transmit authorization information 266 to computing system 220 when a user of mobile device 102 requests emergency services, such as when mobile device 102 is used to make an emergency service call or text message to the emergency dispatch system.

Computing system 220 may distribute (e.g., transmit) authorization information 266 to one or more tracking devices in response to receiving an indication of a request for emergency services. For example, computing system 220 may transmit one or more units of authorization information 266 for a mobile device to one or more tracking devices of emergency responders that are dispatched in response to the request for emergency services from the mobile device.

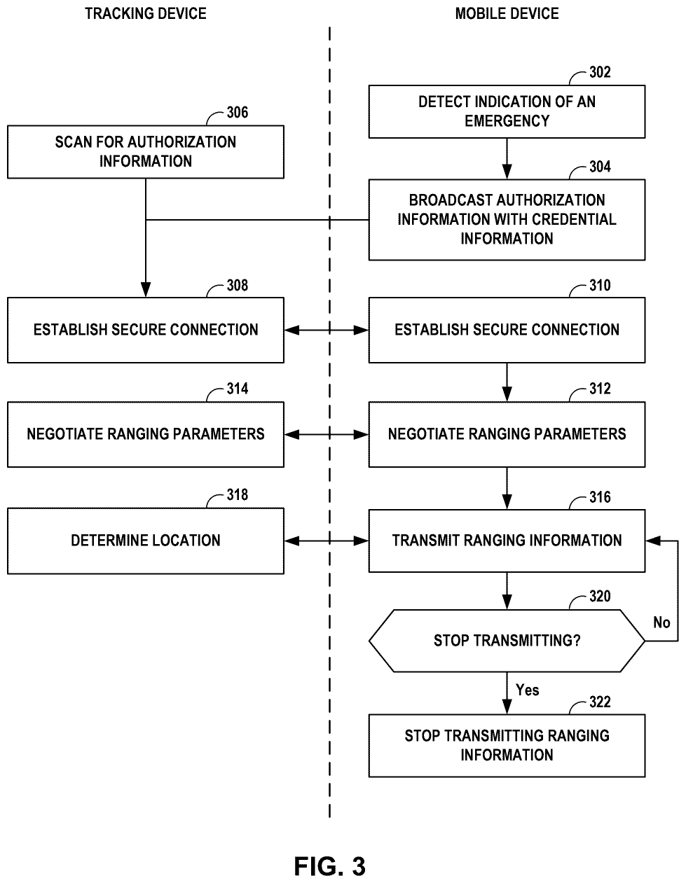

FIG. 3 is a flowchart illustrating a first example process for range tracking authorization for obtaining an emergency response, in accordance with one or more aspects of the present disclosure. In the example of FIG. 3, a mobile device and a tracking device perform range tracking authorization for obtaining an emergency response. FIG. 3 is described below in the context of FIG. 1. For example, the mobile device and the tracking device of FIG. 3 may be an example of mobile device 102 and tracking device 132 of FIG. 1, respectively.

The example process of FIG. 3 may correspond to an emergency, such as an earthquake, where mobile device 102 may broadcast authorization information to tracking device 132 to enable tracking device 132 to determine the location of mobile device 102. In this manner, an emergency responder using tracking device 132 may facilitate providing an emergency response to the user associated with mobile device 102 during the emergency.

Mobile device 102 may detect an indication of the emergency (302). For example, mobile device 102 may receive user or other input indicating an emergency has occurred. As described above, such input may be in the form of user activation of an emergency service mode, dialing emergency services. Mobile device 102 may receive an indication of an emergency in the form of an emergency alert (e.g., extreme weather alert, disaster alert), or through one or more sensors 110, as described above. In response to detecting the indication of the emergency, mobile device 102 may broadcast authorization information including credential information (304). Mobile device 102 may broadcast authorization information including credential information subject to first obtaining user permission and/or consistent with user privacy or other settings.

Tracking device 132 may scan for (e.g., attempt to receive and/or receive) the authorization information (306). Tracking device 132 may scan for authorization information without any knowledge or indication of if mobile device 102 is transmitting the authorization information. Tracking device 132 performs one or more scans for the authorization information when mobile device 102 is broadcasting the authorization information to enable tracking device 132 to receive the authorization information.

By scanning, tracking device 132 may receive the authorization information once the authorization information is broadcast by mobile device 102. Tracking device 132 and mobile device 102 may mutually establish a secure connection (308, 310). For example, tracking device 132 may generate an authorized request based on the authorization information tracking device 132 received from mobile device 102. Tracking device 132 may transmit the authorized request to mobile device 102. Mobile device 102 may validate the authorized request and establish the secure connection with tracking device 132. An example of the secure connection may be direct communication link 128.

Mobile device 102 and tracking device 132 may mutually negotiate one or more ranging parameters (312, 314) such as through the secure connection. For example, mobile device 102 and tracking device 132 may determine parameters of ranging information to be provided by mobile device 102 that are compatible with tracking device 132. For instance, mobile device 102 and tracking device 132 may negotiate to determine a format and/or type of indication of signal strength mobile device 102 can provide that tracking device 132 can receive and parse to determine the location of mobile device 102. To illustrate, mobile device 102 and tracking device 132 may determine that mobile device 102 can provide an indication of signal strength in the form of an RSSI through communication unit 112 of mobile device 102 that communication unit 142 of tracking device 132 can receive and parse to determine a distance between mobile device 102 and tracking device 132.

In some examples, mobile device 102 and tracking device 132 may determine a number of parameters of ranging information that are compatible with tracking device 132. Mobile device 102 and/or tracking device 132 may select one of these parameters to communicate ranging information. For example, mobile device 102 and tracking device 132 may prioritize one or more particular parameters, such as in an order from most to least accurate. For instance, mobile device 102 and tracking device 132 may select an RSSI from a BLUETOOTH communication unit rather than a WI-FI communication unit where both are compatible with tracking device 132.

Mobile device 102 and tracking device 132 may perform negotiation of ranging parameters in various ways. For example, mobile device 102 may compare a list of compatible parameters received from tracking device 132 to a list of compatible parameters of mobile device 102. Alternatively, tracking device 132 may compare a list of compatible parameters received from mobile device 102 to its own list of compatible parameters. Mobile device 102 and/or tracking device 132 may determine one or more parameters that are compatible between mobile device 102 and tracking device 132 by identifying compatible parameters shared between mobile device 102 and tracking device 132. Mobile device and/or tracking device 132 may determine one or more parameters that are compatible between mobile device 102 and tracking device 132 by identifying compatible parameters shared between mobile device 102 and tracking device 132.

Mobile device 102 may transmit ranging information to tracking device 132 (316) based on the negotiated parameter of ranging information. For example, where a BLUETOOTH or other RSSI is the negotiated parameter of ranging information, mobile device 102 may transmit the ranging information to tracking device 132 using BLUETOOTH RSSI. Mobile device 102 may transmit the ranging information to tracking device 132, such as through the secure connection, which tracking device 132 may receive. Tracking device 132 may determine a location for mobile device 102 based on the ranging information (318). For example, tracking device 132 may determine a distance (e.g., 3 m, 5 m, 10 m) to mobile device 102 based on signal strength or other indicators or information from the ranging information. Mobile device 102 may repeatedly transmit the ranging information to tracking device 132 to update the location of mobile device 102 relative to tracking device 132 to assist an emergency responder in locating mobile device 102.

Mobile device 102 may transmit ranging information repeatedly until stopped (320). Tracking device 132 may determine the location of mobile device 102 as mobile device 102 continues to transmit the ranging information, to update the relative location of mobile device 102 relative to tracking device 132. Mobile device 102 may repeatedly transmit the ranging information at a predefined period of time until stopped.

Mobile device 102 may stop transmitting the ranging information in response to various inputs. For example, mobile device 102 may stop transmitting the ranging information in response to user input deactivating the transmissions or deactivating the emergency assistance mode of mobile device 102. In response to such input, mobile device 102 may stop transmitting the ranging information (322).

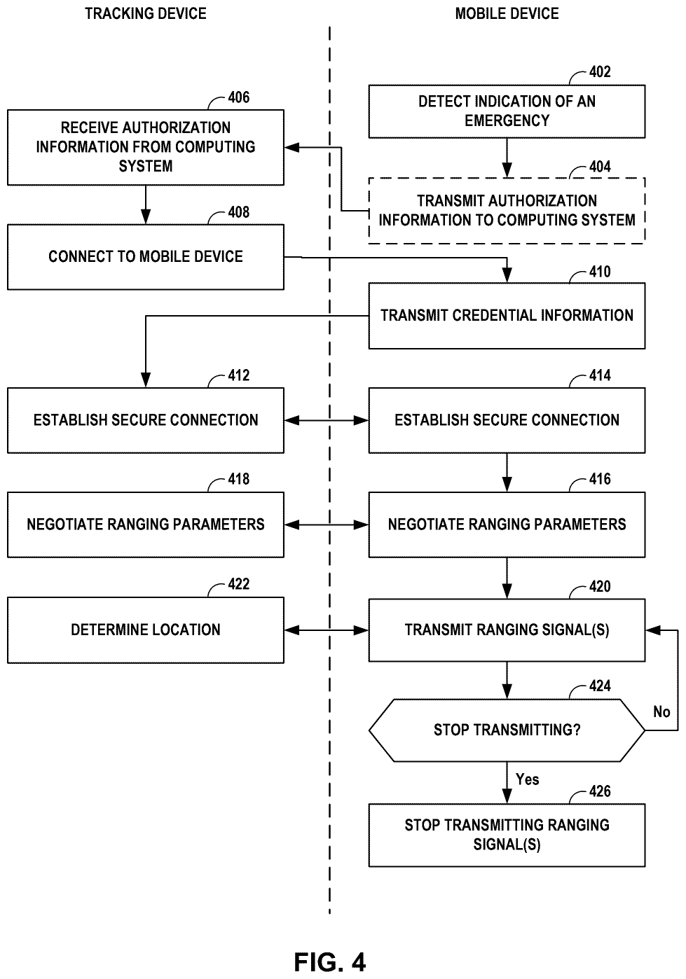

FIG. 4 is a flowchart illustrating a second example process for range tracking authorization for obtaining an emergency response, in accordance with one or more aspects of the present disclosure. In the example of FIG. 4, a mobile device and a tracking device perform range tracking authorization for obtaining an emergency response. FIG. 4 is described below in the context of FIG. 1. For example, the mobile device and the tracking device of FIG. 4 may be an example of mobile device 102 and tracking device 132 of FIG. 1.

The example process of FIG. 4 may correspond to an emergency, such as kidnapping, where mobile device 102 may have previously cached (e.g., stored) authorization information to computing system 120. In emergencies such as kidnappings, it may not be desirable to broadcast the authorization information such as to prevent eavesdroppers, the kidnappers themselves, or other parties (aside from emergency responders) from capturing and using the authorization information to determine the location of mobile device 102. As such, computing system 120, rather than mobile device 102, may provide the authorization information to tracking device 132 of an authorized emergency responder to enable tracking device 132 to determine the location of mobile device 102. In this manner, these other parties cannot obtain the authorization information from a broadcast by mobile device 102 which prevents such other parties from determining the location through mobile device 102.

Similar to FIG. 3, mobile device 102 may detect an indication of the emergency (402). As described above, mobile device 102 may, for example, receive user or other input indicating an emergency has occurred. Such input may be in the form of user activation of an emergency assistance mode, dialing 911. Mobile device 102 may receive an indication of an emergency in the form of an emergency alert (e.g., extreme weather alert, disaster alert), or through one or more sensors 110, as described above.

In response to detecting the indication of the emergency, mobile device 102 may transmit authorization information to computing system 120 (404). As indicated by the broken line depiction thereof, step 404 may be optional in some examples. As described above for example, mobile device 102 may transmit the authorization information to computing system 120 at various times. As such, in some examples, rather than transmitting the authorization information to computing system 120 in response to detecting the indication of the emergency, mobile device 102 may have previously transmitted the authorization information to computing system 120.

Tracking device 132 may receive the authorization information from computing system 120 (406). For example, computing system 120 may constitute an emergency services dispatch system or portion thereof and may provide the authorization information to tracking device 132 as part of transmitting a dispatch instruction or request to dispatch the emergency responder assigned to tracking device 132. Tracking device 132 may connect to mobile device 102 (408), such as through an initial connection, using the authorization information from computing system 120. Mobile device 102 may transmit the credential information to tracking device 132 (410), such as through the initial connection.

Tracking device 132 and mobile device 102 may mutually establish a secure connection (412, 414). For example, tracking device 132 may generate an authorized request based on the credential information tracking device 132 received from mobile device 102. Tracking device 132 may transmit the authorized request to mobile device 102. Mobile device 102 may validate the authorized request and establish the secure connection with tracking device 132. As described above, an example of the secure connection may be direct communication link 128.

Mobile device 102 and tracking device 132 may mutually negotiate one or more ranging parameters (418, 416) such as through the secure connection. As described above, mobile device 102 and tracking device 132 may determine parameters of ranging information to be provided by mobile device 102 that are compatible between mobile device 102 and tracking device 132. For instance, mobile device 102 and tracking device 132 may negotiate to determine a format and/or type of indication of signal strength mobile device 102 can provide that tracking device 132 can receive and parse to determine the location of mobile device 102.

Similar to above, mobile device 102 and tracking device 132 may determine a number of parameters of ranging information that are compatible with tracking device 132. Mobile device 102 and/or tracking device 132 may select one of these parameters to communicate ranging information. For example, mobile device 102 and tracking device 132 may prioritize one or more particular parameters, such as in an order from most to least accurate. For instance, mobile device 102 and tracking device 132 may select an RSSI from a BLUETOOTH communication unit rather than a WI-FI communication unit where both are compatible with tracking device 132.

Mobile device 102 may transmit ranging information to tracking device 132 (420) based on the negotiated parameter of ranging information. For example, where a BLUETOOTH or other RSSI is the negotiated parameter of ranging information, mobile device 102 may transmit the ranging information to tracking device 132 using BLUETOOTH RSSI. Mobile device 102 may transmit the ranging information to tracking device 132, such as through the secure connection, which tracking device 132 may receive. Tracking device 132 may determine a location for mobile device 102 based on the ranging information (422). For example, tracking device 132 may determine a distance (e.g., 3 m, 5 m, 10 m) to mobile device 102 based on signal strength or other indicators or information from the ranging information.

Mobile device 102 may repeatedly transmit the ranging information to tracking device 132 to update the location of mobile device 102 relative to tracking device 132 to assist an emergency responder in locating mobile device 102. Mobile device 102 may transmit ranging information repeatedly until stopped (424), such as described above. Tracking device 132 may determine the location of mobile device 102 as mobile device 102 continues to transmit the ranging information, to update the relative location of mobile device 102 relative to tracking device 132. Mobile device 102 may repeatedly transmit the ranging information at a predefined period of time until stopped, such as in response to various user or other input, such as described above. In response to such input, mobile device 102 may stop transmitting the ranging information (426).

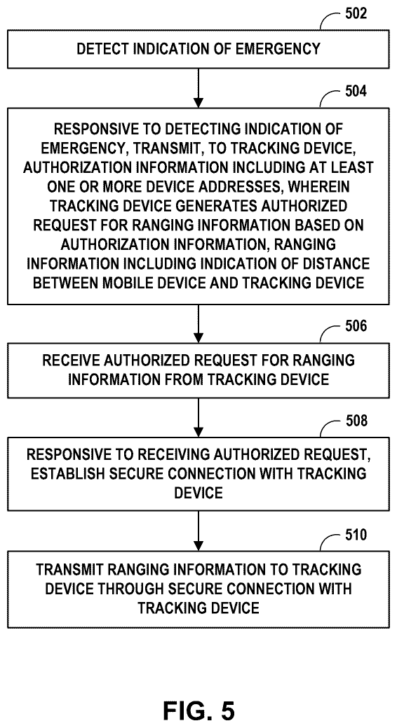

FIG. 5 is a flowchart of an example process for range tracking authorization for obtaining an emergency response, in accordance with one or more aspects of the present disclosure. FIG. 5 is described below in the context of FIG. 1.

Mobile device 102 may detect an indication of an emergency (502). For example, mobile device 102 may detect the indication of the emergency by detecting a user input corresponding to activation of an emergency mode of the mobile device. In some implementations, responsive to detecting the indication of the emergency, mobile device 102 may transmit, to tracking device 132, credential information including one or more of a key, a nonce, or challenge-response information. This credential information may be utilized by tracking device 132 to generate the authorized request for the ranging information based on the authorization information and the credential information.

Responsive to detecting the indication of the emergency, mobile device 102 may transmit authorization information to a tracking device 132 (504). The authorization information may include one or more device addresses. Examples of device addresses include a BLUETOOTH device address, a media access control (MAC) address, and an ultra-wideband address. Tracking device 132 may generate an authorized request for ranging information based on the authorization information. As described above, the ranging information may include an indication of a distance between the mobile device and the tracking device.

Mobile device 102 may repeatedly transmit the authorization information until stopped. For example, mobile device 102 may periodically transmit the authorization information until mobile device 102 receives an indication (e.g., confirms) the authorization information has been received by tracking device 132.

In some examples, to transmit the authorization information to tracking device 132, mobile device 102 may transmit the authorization information to computing system 120. For example, mobile device 102 may cache the authorization information at computing system 120. Computing system 120 may store and transmit the authorization information to tracking device 132.

Mobile device 102 may receive the authorized request for ranging information from the tracking device (506). Responsive to receiving the authorized request, mobile device 102 may establish a secure connection with tracking device 132 (508). For example, mobile device 102 and tracking device 132 may establish an encrypted connection, such as with credential information provided by mobile device 102 separately from the authorization information or as part of the authorization information.

Mobile device 102 may transmit the ranging information to tracking device 132 through the secure connection with tracking device 132 (510). The ranging information may include one or more indications of signal strength (e.g., RSSI). Tracking device 132 may determine the location (e.g., distance) of mobile device 102 based on the indication of signal strength. Mobile device 102 may repeatedly transmit the ranging information to tracking device 132, such as to update the location of mobile device 102 as an emergency responder moves with tracking device 132 in locating mobile device 102.

This disclosure includes the following examples.

Example 1: A method includes detecting, by a mobile device, an indication of an emergency; responsive to detecting the indication of the emergency, transmitting, by the mobile device and to a tracking device, authorization information including at least one or more device addresses to cause the tracking device to generate an authorized request for ranging information based on the authorization information, the ranging information including an indication of a distance between the mobile device and the tracking device; receiving, by the mobile device, the authorized request for ranging information from the tracking device; responsive to receiving the authorized request, establishing, by the mobile device, a secure connection with the tracking device; and transmitting, by the mobile device and using the secure connection with the tracking device, the ranging information to the tracking device.

Example 2: The method of example 1, further includes responsive to detecting the indication of the emergency, transmitting, by the mobile device and to the tracking device, credential information including one or more of a key, a nonce, or challenge-response information to cause the tracking device to generate the authorized request for the ranging information based on the authorization information and the credential information.

Example 3: The method of example 1, wherein transmitting the authorization information to the tracking device comprises transmitting, by the mobile device, the authorization information to a computing system to cause the computing system to transmit the authorization to the tracking device.

Example 4: The method of example 1, wherein the ranging information comprises one or more indications of signal strength of the mobile device.

Example 5: The method of example 1, wherein the one or more device addresses are one or more of a BLUETOOTH device address, a media access control (MAC) address, or an ultra-wideband address.

Example 6: The method of example 1, wherein detecting the indication of the emergency comprises detecting, by the mobile device, a user input corresponding to activation of an emergency mode of the mobile device.

Example 7: The method of example 1, wherein transmitting, to the tracking device, the authorization information comprises periodically transmitting, by the mobile device, the authorization information.

Example 8: A mobile device includes a memory that stores instructions; and one or more processors that execute the instructions to: detect an indication of an emergency; responsive to detecting the indication of the emergency, transmit, to a tracking device, authorization information including at least one or more device addresses to cause the tracking device to generate an authorized request for ranging information based on the authorization information, the ranging information including an indication of a distance between the mobile device and the tracking device; receive the authorized request for ranging information from the tracking device; responsive to receiving the authorized request, establish a secure connection with the tracking device; and transmit, using the secure connection with the tracking device, the ranging information to the tracking device.

Example 9: The mobile device of example 8, wherein the one or more processors execute the instructions to, responsive to detecting the indication of the emergency, transmit, to the tracking device, credential information including one or more of a key, a nonce, or challenge-response information to cause the tracking device to generate the authorized request for the ranging information based on the authorization information and the credential information.

Example 10: The mobile device of example 8, wherein to transmit the authorization information to the tracking device the one or more processors execute the instructions to transmit the authorization information to a computing system to cause the computing system to transmit the authorization to the tracking device.

Example 11: The mobile device of example 8, wherein the ranging information comprises one or more indications of signal strength of the mobile device.

Example 12: The mobile device of example 8, wherein the one or more device addresses are one or more of a BLUETOOTH device address, a media access control (MAC) address, or an ultra-wideband address.

Example 13: The mobile device of example 8, wherein to detect the indication of the emergency the one or more processors execute the instructions to detect a user input corresponding to activation of an emergency mode of the computing device.

Example 14: The mobile device of example 8, wherein to transmit, to the tracking device, the authorization information the one or more processors execute the instructions to periodically transmit the authorization information.

Example 15: Non-transitory computer-readable storage media storing instructions that, when executed, cause one or more processors of a mobile device to: detect an indication of an emergency; responsive to detecting the indication of the emergency, transmit, to a tracking device, authorization information including at least one or more device addresses to cause the tracking device to generate an authorized request for ranging information based on the authorization information, the ranging information including an indication of a distance between the mobile device and the tracking device; receive the authorized request for ranging information from the tracking device; responsive to receiving the authorized request, establish a secure connection with the tracking device; and transmit, using the secure connection with the tracking device, the ranging information to the tracking device.

Example 16: The non-transitory computer-readable storage media of example 15, wherein the instructions, when executed, cause the one or more processors to, responsive to detecting the indication of the emergency, transmit, to the tracking device, credential information including one or more of a key, a nonce, or challenge-response information to cause the tracking device to generate the authorized request for the ranging information based on the authorization information and the credential information.

Example 17: The non-transitory computer-readable storage media of example 15, wherein to transmit the authorization information to the tracking device the instructions, when executed, cause the one or more processors to transmit the authorization information to a computing system to cause the computing system to store and transmit the authorization to the tracking device.

Example 18: The non-transitory computer-readable storage media of example 15, wherein the ranging information comprises one or more indications of signal strength of the mobile device.

Example 19: The non-transitory computer-readable storage media of example 15, wherein the one or more device addresses are one or more of a BLUETOOTH device address, a media access control (MAC) address, or an ultra-wideband address.

Example 20: The non-transitory computer-readable storage media of example 15, wherein to detect the indication of the emergency the instructions, when executed, cause the one or more processors to detect a user input corresponding to activation of an emergency mode of the mobile device.

Example 21: The non-transitory computer-readable storage media of example 15, wherein to transmit, to the tracking device, the authorization information the instructions, when executed, cause the one or more processors to periodically transmit the authorization information.

Example 22: A computer-program product that includes instructions that cause one or more processors to perform any combination of the methods of examples 1-8.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is also termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above may also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily need realization by different hardware units. Rather, as described above, various units may be combined in a hardware unit or provided by a collection of interoperable hardware units, including one or more processors as described above, in conjunction with suitable software and/or firmware.

It is to be recognized that, depending on the example, certain acts or events of any of the methods described herein may be performed in a different sequence, may be added, merged, or left out altogether (e.g., not all described acts or events are present in every implementation for the practice of the method). Moreover, in certain implementations, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. A method comprising:
detecting, by a mobile device, an indication of an emergency;
responsive to detecting the indication of the emergency, transmitting, by the mobile device and to a tracking device, authorization information including at least one or more device addresses to cause the tracking device to generate an authorized request for ranging information based on the authorization information, the ranging information including an indication of a distance between the mobile device and the tracking device;
receiving, by the mobile device, the authorized request for ranging information from the tracking device;
responsive to receiving the authorized request, establishing, by the mobile device, a secure connection with the tracking device; and
transmitting, by the mobile device and using the secure connection with the tracking device, the ranging information to the tracking device.

2. The method of claim 1, further comprising:
responsive to detecting the indication of the emergency, transmitting, by the mobile device and to the tracking device, credential information including one or more of a key, a nonce, or challenge-response information,
wherein the tracking device generates the authorized request for the ranging information based on the authorization information and the credential information.

3. The method of claim 1,
wherein transmitting the authorization information to the tracking device comprises transmitting, by the mobile device, the authorization information to a computing system to cause the computing system to store and transmit the authorization information to the tracking device.

4. The method of claim 1, wherein the ranging information comprises one or more indications of signal strength of the mobile device.

5. The method of claim 1, wherein the one or more device addresses are one or more of a BLUETOOTH device address, a media access control (MAC) address, or an ultra-wideband address.

6. The method of claim 1, wherein detecting the indication of the emergency comprises detecting, by the mobile device, a user input corresponding to activation of an emergency mode of the mobile device.

7. The method of claim 1, wherein transmitting, to the tracking device, the authorization information comprises periodically transmitting, by the mobile device, the authorization information.

8. A mobile device comprising:
a memory that stores instructions; and
one or more processors that execute the instructions to:
detect an indication of an emergency;
responsive to detecting the indication of the emergency, transmit, to a tracking device, authorization information including at least one or more device addresses to cause the tracking device to generate an authorized request for ranging information based on the authorization information, the ranging information including an indication of a distance between the mobile device and the tracking device;
receive the authorized request for ranging information from the tracking device;
responsive to receiving the authorized request, establish a secure connection with the tracking device; and
transmit, using the secure connection with the tracking device, the ranging information to the tracking device.

9. The mobile device of claim 8, wherein the one or more processors execute the instructions to, responsive to detecting the indication of the emergency, transmit, to the tracking device, credential information including one or more of a key, a nonce, or challenge-response information to cause the tracking device to generate the authorized request for the ranging information based on the authorization information and the credential information.

10. The mobile device of claim 8, wherein to transmit the authorization information to the tracking device the one or more processors execute the instructions to transmit the authorization information to a computing system to cause the computing system to store and transmit the authorization information to the tracking device.

11. The mobile device of claim 8, wherein the ranging information comprises one or more indications of signal strength of the mobile device.

12. The mobile device of claim 8, wherein the one or more device addresses are one or more of a BLUETOOTH device address, a media access control (MAC) address, or an ultra-wideband address.

13. The mobile device of claim 8, wherein to detect the indication of the emergency the one or more processors execute the instructions to detect a user input corresponding to activation of an emergency mode of the mobile device.

14. The mobile device of claim 8, wherein to transmit, to the tracking device, the authorization information the one or more processors execute the instructions to periodically transmit the authorization information.

15. Non-transitory computer-readable storage media storing instructions that, when executed, cause one or more processors of a mobile device to:
detect an indication of an emergency;
responsive to detecting the indication of the emergency, transmit, to a tracking device, authorization information including at least one or more device addresses to cause the tracking device to generate an authorized request for ranging information based on the authorization information, the ranging information including an indication of a distance between the mobile device and the tracking device;
receive the authorized request for ranging information from the tracking device;
responsive to receiving the authorized request, establish a secure connection with the tracking device; and
transmit, using the secure connection with the tracking device, the ranging information to the tracking device.

16. The non-transitory computer-readable storage media of claim 15, wherein the instructions, when executed, cause the one or more processors to, responsive to detecting the indication of the emergency, transmit, to the tracking device, credential information including one or more of a key, a nonce, or challenge-response information to cause the tracking device to generate the authorized request for the ranging information based on the authorization information and the credential information.

17. The non-transitory computer-readable storage media of claim 15, wherein to transmit the authorization information to the tracking device the instructions, when executed, cause the one or more processors to transmit the authorization information to a computing system to cause the computing system to store and transmit the authorization information to the tracking device.

18. The non-transitory computer-readable storage media of claim 15, wherein the ranging information comprises one or more indications of signal strength of the mobile device.

19. The non-transitory computer-readable storage media of claim 15, wherein to detect the indication of the emergency the instructions, when executed, cause the one or more processors to detect a user input corresponding to activation of an emergency mode of the mobile device.

20. The non-transitory computer-readable storage media of claim 15, wherein to transmit, to the tracking device, the authorization information the instructions, when executed, cause the one or more processors to periodically transmit the authorization information.
